(19) United States
(12) Patent Application Publication
(10) Pub. No.: US 2005/0279027 A1
(43) Pub. Date: Dec. 22, 2005

(54) Weatherstrip

(75) Inventors: Hideshi Tsuchida, Hiroshima (JP); Tsuyoshi Noda, Tokyo (JP)

Correspondence Address: FRISHAUF, HOLTZ, GOODMAN & CHICK, PC, 220 5TH AVE FL 16, NEW YORK, NY, 10001-7708, US

(73) Assignees: Nishikawa Rubber Co., Ltd., Hiroshima (JP); Mitsubishi Jidosha Kogyo Kabushikikaisha, Tokyo (JP)

(21) Appl. No.: 11/122,507

(22) Filed: May 4, 2005

(30) Foreign Application Priority Data
Jun. 17, 2004 (JP) 2004-179718

(51) Int. Cl. E06B 7/16

(52) U.S. Cl. 49/495.1

(57) ABSTRACT

A weatherstrip attached to the edge of the roof or the front pillar in a hard-top vehicle or an open-top vehicle, that seals the periphery of the door glass with a seal of a hollow seal and a sealing lip when a door is closed, the weatherstrip including the hollow seal, and the lip that protrudes toward the side from the sidewall by having a specified gap from the seal, the hollow seal and the sealing lip being flexed without being influenced by each other, the flexed configurations of the hollow seal and the sealing lip being easily predicted, so target flexed configurations can be easily obtained. The hollow seal entirely covers an edge of the door glass, and not only the edge but a portion of the glass surface at the exterior side beyond the edge are also covered and sealed.

### CROSS-REFERENCE TO THE RELATED ART

This application incorporates by reference the subject matter of Application No. 2004-179718, filed in Japan on Jun. 17, 2004, on which a priority claim is based under 35 U.S.C §199(a).

### BACKGROUND OF THE INVENTION

1. Field of the Invention

The present invention relates to a weatherstrip attached to the edge of a door opening in a hardtop or an open-top vehicle body, and that seals the periphery of the door glass when the door is closed.

2. Description of the Related Art

FIG. 3 shows an open-top vehicle of a type where a roof 21 is opened by folding, and a weatherstrip is attached to a front pillar 24 or the edge of a roof 21 for the purpose of sealing the periphery of door glass 23 when a door 22 is closed. For this type of weatherstrip, there are a single-sealing type and a double seal type. FIG. 4 shows the former single-sealing type, a weatherstrip 25, which is attached to the edge of the roof, provided with a base 27, which is attached to a holder 26 installed to the edge of the roof, a sidewall 28, and a seal 29 formed a hollow seal along with the base 27 and the sidewall 28, and designed such that sealing the periphery of the door glass is performed only by the seal 29 when the roof 21 is closed and the door glass 23 rises.

FIG. 5 shows the latter double seal type, a weatherstrip 31, provided with a base 33, attached to a holder 32 installed to the edge of the roof, a sidewall 34, a seal 35 formed a hollow seal along with the base 33 and the sidewall 34, and a lip 36 formed by having a specified gap from the seal 35, designed such that sealing the periphery of the door glass 23 is performed by double-sealing, by the seal 35 and the lip 36.

The above description relates to a weatherstrip attached to the edge of the roof in an open-top vehicle, and a weatherstrip attached to the front pillar 24 also has the same structure. A weatherstrip attached to the front pillar or the edge of the roof in a hard-top vehicle has basically the same structure, as well.

In the single-seal type weatherstrip 25 shown in FIG. 4, covering an edge 23a at the end of the door glass 23 by the seal 29 results in preventing direct splash by high-pressure water beyond the edge 23a when a car is washed, and then sealing is performed. In the meantime, in the double-seal weatherstrip 31 shown in FIG. 5, the seal 35 makes contact with the edge 23a, so even though the high-pressure water penetrates from between the seal 35 and the edge 23a, it is designed to stop the water by the lip 36, and since the water pressure is considerably mitigated by the seal 35, the water can be stopped even by the lip 36, the reaction force of which is weak.

The present invention is a weatherstrip where the addition of an improvement to the double seal type weatherstrip has resulted in the more secure sealing.

### SUMMARY OF THE INVENTION

The present invention relates to a weatherstrip attached to the edge of a door opening in a vehicle body, that seals the periphery of the door glass when closing the door. The weatherstrip is provided with a base installed at the edge of the door opening in a vehicle body, a sidewall formed by rising from the base, and a seal forming a hollow seal along with the sidewall and the above-mentioned base and that covers the end of the door glass along the end when closing the door, and a lip that extends toward the outside of the vehicle body from the above-mentioned sidewall, and, the lip makes contact with the side of the door glass by having a specified gap from the seal when closing the door.

### BRIEF DESCRIPTION OF THE DRAWINGS

FIG. 1 shows a weatherstrip attached to the edge of the roof in an open-top vehicle, shown in FIG. 3, and is a cross-sectional view of 1-1 line in FIG. 3.

FIG. 2 shows a weatherstrip attached to the front pillar, and is a cross-sectional view of 2-2 line in FIG. 3.

FIG. 3 is a perspective view that shows one side of the open-top vehicle.

FIG. 4 is a cross-sectional view of a conventional single-sealing type weatherstrip, which corresponds to the weatherstrip shown in FIG. 1.

FIG. 5 is a cross-sectional view of a conventional double seal type weatherstrip.

### DESCRIPTION OF THE PREFERRED EMBODIMENT

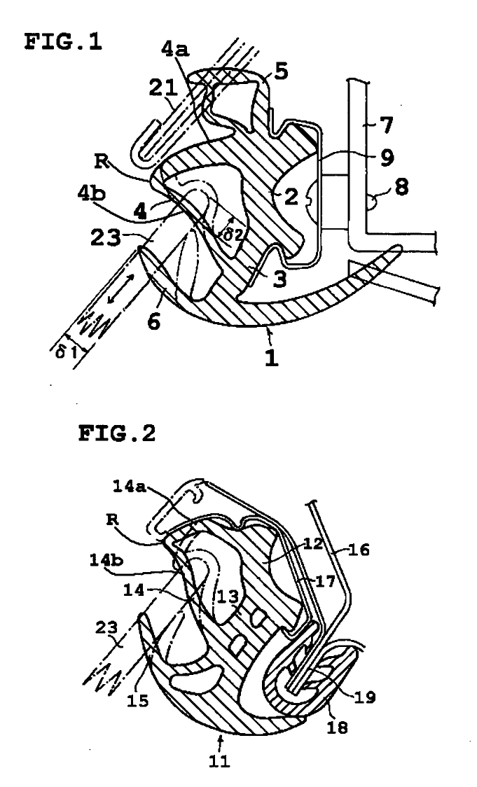

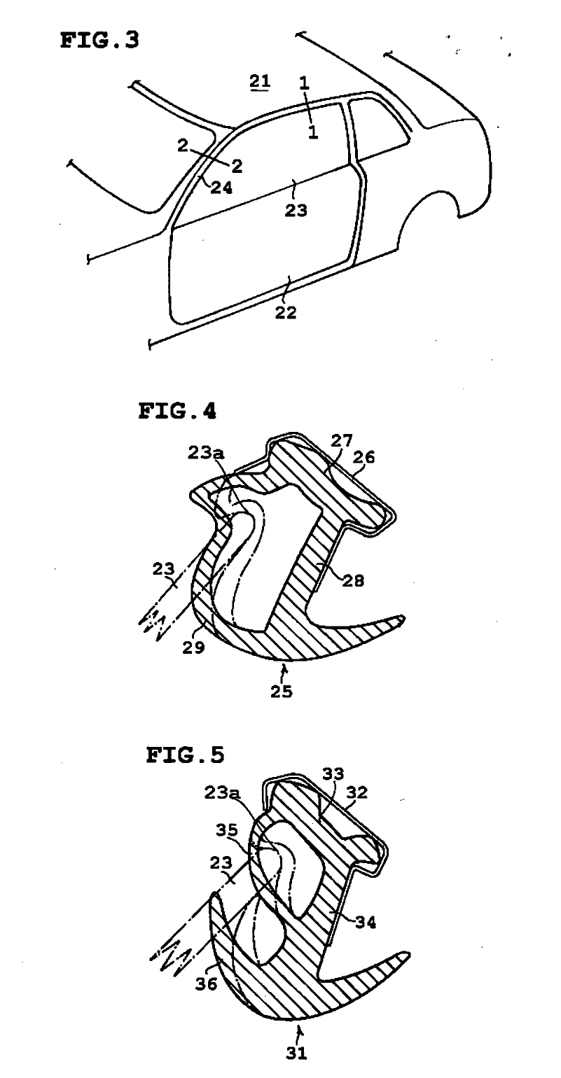

FIG. 1 shows a weatherstrip 1 attached to the edge of a foldable roof 21 of the open-top vehicle shown in FIG. 3. The weatherstrip 1 is provided with a base 2, a 1st sidewall 3 that protrudes toward inside of the vehicle from the base 2, the thickness of which is comparatively thick, and which is nearly equal to that of the base 2, and a 2nd sidewall 4a that protrudes toward the exterior of the vehicle from the base 2. Concurrently, the weatherstrip 1 comprises a seal 4b joined to the intermediate portion of the 1st sidewall 3 and the end of the 2nd sidewall 4a, and forming a hollow seal 4 formed along with the base 2, a hollow sub-seal 5 protrudingly formed upward from the base 2, and a lip 6 orientated toward the outside of the body from the hollow seal 4 and is protrudingly formed toward the side from the lower end of the sidewall 3, designed so that the base 2 is attached to a holder 9, fixed to a link 7 installed to the edge of the roof using a screw 8.

Since the thickness of the 1st sidewall 3 is comparatively thick, and nearly equal to that of the base 2, and its rigidity is also great, and it is difficult to be influenced by the deformation of the seal 4b.

The sub-seal 5 is elastically joined with the roof 21 when the roof 21 is closed, and has a function to stop the penetration of water through from between the roof 21 and the hollow seal 4 when the car is washed using high-pressure water.

When the door glass 23 rises and the glass is closed, the lip 6 makes contact with the door glass 23 and is sealed by refracting, as shown by the broken line in FIG. 1, and the lap d1 shown in FIG. 1 at this time is substantially nearly equal to 4-7 mm, similar to the lap d2 of the seal 4b. Herein, the lap d1 of the lip comprises a gap between the inner surface of the glass and the end of lip along the through-thickness direction, and the lap d2 of the seal comprises a gap between the position where the door glass 23 makes contact with the seal 4 when the door glass 23 rises and the glass is closed, and the position of the end of the door glass 23 when the door glass 23 reaches the upper end and the glass is closed. The reason the lap d1 of the lip and the lap d2 of the seal are both established at 4-7 mm is because if the lap d1 of the lip is less than 4 mm, when the door glass is pushed toward the exterior of the vehicle due to the reaction force of the lip, the seal pressure of the lip on the door glass becomes insufficient, and if the lap d1 of the lip exceeds 7 mm, the reaction force of the lip to the door glass becomes greater, and the door closing properties deteriorate.

Weatherstrip 1 is also equipped with at least 3 items, preferably all items, from among the following 6 items:
(1) The angle formed by the seal 4b, which is joined with the end of the 2nd sidewall 4a, and the 2nd sidewall 4a is acute, where by when the door glass rises and the glass is closed, the seal is easily flexed toward the inside of the hollow seal, making it easier to cover the edge at the end of the door glass, result in a more secure seal.
(2) The joined portion between the seal 4b and the end of the 2nd sidewall 4a is chamfered, the radius of the chamfered portion R being within the range of 0.1 through 1.5 mm. The reason the radius of the chamfered portion R is established within the range of 0.1 through 1.5 mm is because the configuration formation is difficult if radius is less than 0.1 mm. On the other hand, if radius exceeds 1.5 mm, the covering properties of the glass deteriorate.
(3) With respect to seal 4b, the joint with the 1st sidewall 3 is lower than the joint with the 2nd sidewall 4a along the door glass 23.
(4) The rigidity of the 1st sidewall 3 is greater than that of the 2nd sidewall 4a.
(5) In the seal 4b, the thickness of the base at the 1st sidewall 3 side is thicker than that of the base at the 2nd sidewall 4a side, and the rigidity is greater.
(6) The position of the door glass 23 is established to make contact with the seal 4b, not in the center but on the vehicle exterior side.

With the weatherstrip in the present embodiment, when the door glass 23 rises and the glass is closed, it is designed such that edge 23a is covered with the seal 4b of the hollow seal 4 along the upper end of the door glass 23, and not only the edge 23a but also even a portion of the glass surface at the exterior side beyond the edge 23a is covered and this results in more secure sealing, so the penetration of high-pressure water can be prevented when a car is washed, and even if the high-pressure water penetrates through, the lip 6 stops the water; therefore, sealing becomes more secure, and it is unnecessary for the lip 6 to have a strong reaction force. Further, the seal 4b of the hollow seal 4 and the lip 6 are flexed without being influenced by deformation from each other when the door glass 23 is closed, and since it is easy to predict the flexed configurations, target flexed configurations can be easily obtained.

FIG. 2 shows a weatherstrip 11 attached to the front pillar 24 of the open-top vehicle shown in FIG. 3. This weatherstrip 11, in a manner similar to the above-mentioned weatherstrip 1, is provided with a base 12, a 1st sidewall 13 that protrudes toward the interior side from the base 12, and whose thickness is comparatively thick, which is nearly equal to that of the base 12, a 2nd sidewall 14a that protrudes toward the exterior side of the vehicle from the base 12. Concurrently, the weatherstrip 11 comprises a seal 14b joined with the intermediate portion of the 1st sidewall 13 and the end of the 2nd sidewall 14a, and forming a hollow seal 14 along with the above-mentioned base 12, and a lip 15 orientated toward the outside of the body from the hollow seal 14, and that is protrudingly formed toward the side from the lower end of the sidewall. The base 12 is attached to a holder 17, which is installed to a frame 16 comprising the front pillar 24, and both the seal 14b of the hollow seal 14 and the lip 15 are elastically deformed and seal the door glass 23, similar to the seal 4a of the hollow seal 4 in the weatherstrip 1 shown in FIG. 1.

In the drawing, the symbol 18 is a trim formed in the frame 16, attached to a flange 19.

The weatherstrip 11 for the present embodiment is also effective similar to the weatherstrip 1 shown in FIG. 1.

The weatherstrips 1 and 11 in each of the above-mentioned embodiments are attached to the edge of the roof and the front pillar in an open-top vehicle, respectively. However, weatherstrips attached to the edge of the roof and the front pillar in a hard-top vehicle can be similarly constructed.

1. A weather strip, wherein, in a weatherstrip attached to the edge of a door opening in a vehicle body, and that seals the periphery of the door glass when the door is closed, the weatherstrip is provided with a base installed to the edge of the door opening, a sidewall formed by rising from the base, and a seal that forms a hollow seal along with the sidewall and the base and that covers the door glass along the end when closing the door, and a lip that extends toward the outside of the vehicle body from the sidewall and that makes contact with the side of the door glass when closing the door.

2. The weatherstrip according to claim 1, wherein, the sidewall comprises a second sidewall on the exterior side of the vehicle and a first sidewall at the interior side of the vehicle, and the second sidewall and the seal are joined by forming an acute angle.

3. The weatherstrip according to claim 1, wherein, the lip is protrudingly formed from the sidewall with a specified gap between the seal, and when the glass is closed, the hollow seal is not in conjunction with the lip, but both independently seal between the door glass.

4. A weatherstrip according to claim 1, wherein, a lap d1n of the lip and a lap d2 of the hollow seal by the door glass are both established to be 4 through 7 mm.

5. The weatherstrip according to claim 2, wherein, the lip is protrudingly formed from the sidewall with a specified gap between the seal, and when the glass is closed, the hollow seal is not in conjunction with the lip, but both independently seal between the door glass.

6. A weatherstrip according to claim 2, wherein, a lap d1n of the lip and a lap d2 of the hollow seal by the door glass 23 are both established to be 4 through 7 mm.
